(19) United States
(12) Patent Application Publication
(10) Pub. No.: US 2003/0029340 A1
(43) Pub. Date: Feb. 13, 2003

(54) Method and apparatus for printing a document that when electronically scanned reveals security graphics

(76) Inventor: Gregory S. Kussmann, Orange, CA (US)

Correspondence Address: Price and Gess, Suite 250, 2100 S.E. Main Street, Irvine, CA, 92614-6238, US

(21) Appl. No.: 09/924,838

(22) Filed: Aug. 8, 2001

(51) Int. Cl. B41F 1/54

(52) U.S. Cl. 101/485

(57) ABSTRACT

The present invention is a method and apparatus for printing documents such as checks that includes an almost imperceptible security image or string of characters on the original face of the document. However, a scanned image of the original document (such as a photocopy) includes a clearly visible presentation of the security image or string of characters that distinguishes the photocopy from the original. The method of creating the security image involves printing a background of a gray scale, removing a portion of the gray scale in the shape of a security image or text, and printing a second gray scale in the removed area causing the two gray scales to appear as one, but where a scanned image of the document distinguishes the two gray scales to reveal the security image.

### BACKGROUND OF THE INVENTION

1. Field of the Invention

The present invention relates generally to document printing, and in particular to a method and apparatus for combating fraud by generating security graphics on a scanned replication (analog or digital) of the original document thereby identifying the copy as such.

2. Description of Related Art

A negative consequence of the recent advances in information technology has been a dramatic increase in white collar crime, especially check fraud. Check fraud may take the form of forged signatures on legitimate blank checks, forged endorsements of stolen checks, alteration of information on a legitimate check, and counterfeit checks. Technology, such as color copying and desk top publishing makes counterfeit checks the fastest growing type of check fraud.

With the aid of new software and better print technology, check forgers, who once had to steal blank checks from mail boxes or offices, now just print their own. Printed on a color background with crisp laser type, counterfeit checks can be made to look very authentic. Because checks look authentic, busy retailers don't question their validity. Forgers often use the name of a respected local manufacturer or institution on the check so that store clerks are unlikely to be suspicious.

Currently, various methods are employed in an attempt to limit check fraud. These include positive pay, reverse positive pay, image positive pay, and thumbprint verification. Positive pay is a check fraud prevention method where a bank will only pay those checks that match all the criteria listed in a file sent by the company that issued the check. In contrast, reverse positive pay requires a bank to obtain the customer's approval before paying checks. Image positive pay is similar to reverse positive pay, except the customer receives an image of the check. There are at least two different thumbprint verification systems that scan the thumb of the person attempting to cash the check.

However, there are many problems with the current check fraud methods. Both reverse positive pay and image positive pay are labor intensive and image positive pay may actually cost more than the fraud it is designed to prevent. Positive pay is probably the least labor intensive of the three, but some banks to not offer a positive pay program. Thumbprint verification is expensive and requires expensive equipment be installed at the point of receipt, and the technology is still being evaluated. The art is in need of a simple, inexpensive method and apparatus for reducing check fraud.

### SUMMARY OF THE INVENTION

The Figures accompanying the specification are provided to illustrate the concept of the present invention. However, the line spacing has been increased to allow the patent application copy to be legible when copied, which distorts the invention. Accordingly, the drawings are not to be literally interpreted as embodying the invention but rather are used to illustrate and edify the following descriptions. Additionally, throughout the remainder of this specification the word “check” will be used to refer to the type of document on which the method of the present invention is being carried out. This is for convenience only, and should in no way limit the scope of the present invention to checks. It is readily apparent that the present invention would be of useful with many types of documents where fraud may be used to alter the document or where duplication of the document could lead to fraud.

The present invention is a method and apparatus for printing checks that includes an almost imperceptible security image or string of characters on the original face of the document. However, a scanned image of the original document (such as a photocopy) includes a clearly visible presentation of the security image or string of characters that distinguishes the photocopy from the original. Throughout the specification, the term “graphics” shall be used to mean both text as well as pictures or images. The invention uses a background comprising, for example, a series of closely spaced parallel lines that appear to the casual observer as a gray scale between the color of the lines and the color of the field. When printing the document, selected areas on the face of the original document that are to be devoid of the security graphics, such as for example the amount box, are identified.

The present invention places a gray scale comprising a series of the closely spaced parallel lines over the entire check surface. A second printing operation removes the gray scale in the areas to be devoid of the any printing, and the shape of the security graphics is also removed leaving a white or blank outline of the security graphics. Then, a new gray scale having the identical line thickness and spacing of the first gray scale, but where the lines have a different angular orientation to the first gray scale, is printed over the outline of the security graphics. The result is a document that appears to be of a uniform gray scale to the casual observer, but in reality includes two sets of parallel lines where the first set forms a background and a second set forms security graphics.

A scanning operation performed by, for example, photocopying machine does not perceive the two sets of parallel lines as having the same density. The scanning operation is carried out by a raster scanning technique which reads a line in a horizontal direction far more efficiently than a line at an angle from the horizontal. At some angles the parallel lines are almost completely ignored by the scanning operation, leaving the scanned image as blank. Conversely, the horizontal and vertical lines are completely perceived by the scanning operation, thereby reproducing the gray scale. By selectively orienting the two sets of parallel lines to emphasize the difference in the photocopying machine's perceived density of the background and the security graphics, a stark contrast can be achieved between the original document and the photocopied document despite a virtual uniform appearance to the human eye.

### BRIEF DESCRIPTION OF THE DRAWINGS

The exact nature of this invention, as well as its objects and advantages, will become readily apparent upon reference to the following detailed description when considered in conjunction with the accompanying drawings, in which like reference numerals designate like parts throughout the figures thereof, and wherein:

FIG. 1 illustrates a preferred embodiment of a first gray scale;

FIG. 2 illustrates a preferred embodiment of a second gray scale;

FIG. 3 illustrates a preferred embodiment of a visual interference pattern;

FIG. 4 illustrates a preferred embodiment of a document after the erase step of the present invention;

FIG. 5 illustrates a preferred embodiment of a document after the inclusion of a visual interference pattern;

FIG. 6 illustrates a preferred embodiment of a document of the present invention; and

FIG. 7 illustrates a preferred embodiment of a scanned version of the document of FIG. 6.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a method and apparatus for printing checks and other documents that when photocopied generate a distinct security image on the photocopy that is not readily perceivable to a casual observer.

Some of the principles of interference patterns used in the present invention were originally discussed by Moiré, and the optical interference effect bears his name. However, the present method and the resulting document and apparatus for generating the document are novel and unique to the particular application. A description of the method for carrying out the present invention is set forth below followed by a description of the document produced by such method.

The present invention utilizes a characteristic of Moiré patterns, an optical effect that occurs when two similar grids overlap each other. A series of fringe patterns result from the interference between the two grids, and the fringe patterns are highly sensitive to the angular offset between the two grids. With documents that include grids or closely spaced parallel lines, Moiré fringes are an important consideration when the document is scanned due to the interference between the reflection of the image and the lines on the original. As a result of this phenomena, Moiré fringes can cause gaps or voids in a scanned image of a document with a closely spaced set of lines. The present invention has utilized this effect to its advantage in developing a document fraud prevention method and apparatus.

The methodology discussed herein is available for use with any dot-oriented marking technology such as laser printers, inkjet printers, and so forth. The invention takes advantage of existing page description language (PDL) characteristics which are typically generic to most PDLs and is not specific to any particular PDL. For example, one embodiment of the present invention can be configured using a Hewlett Packard LaserJet printer with the Hewlett Packard PCL 5E PDL. Other combinations of printing equipment and PDL are within the scope of the present invention and the foregoing is mentioned only as illustrative of one single embodiment that can be used to achieve the present invention.

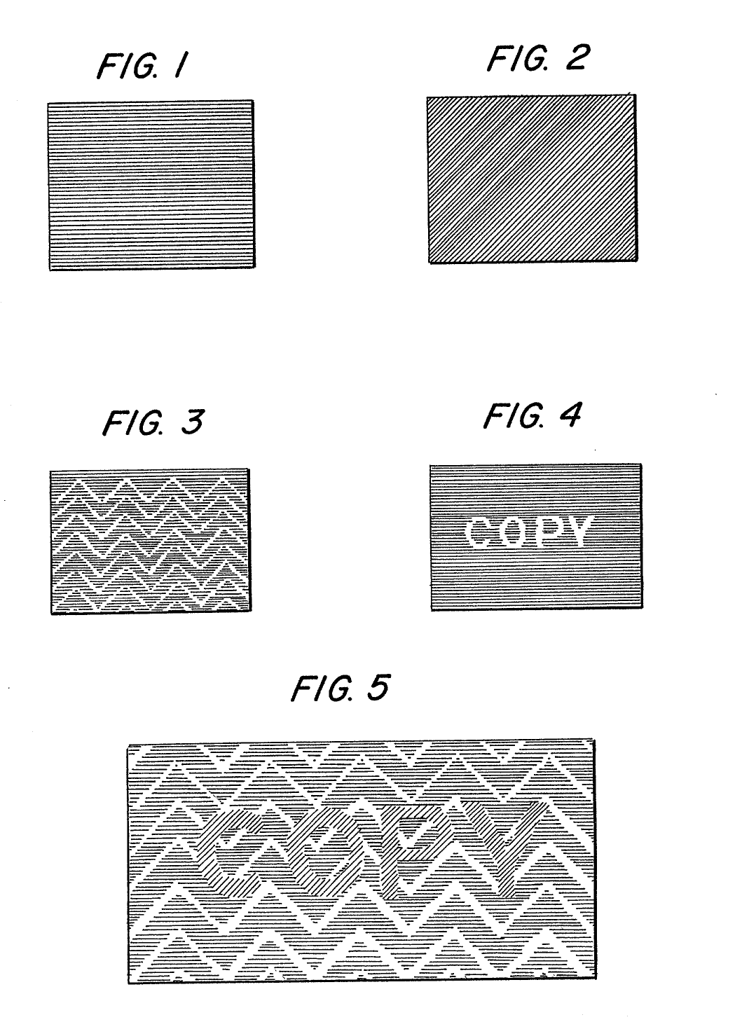

A printer is first supplied with a two gray scale patterns, each comprising a pattern of closely spaced parallel lines. The exact thickness of the lines and the relative spacing between the lines determine the shade of the gray scale. However, to make the security graphics on the original document as inconspicuous as possible it is preferable to have the two gray scale patterns of equal spacing and line thickness, but of different angular orientation. FIGS. 1 and 2 illustrate two types of gray scale comprising a horizontal line gray scale and a 30 degree gray scale, respectively. The field generated by the two gray scales appear nearly identical to the casual observer.

In addition to the two sets of gray scale described above, the printer is typically supplied with a printer-resident font that can be used to generate an outline in the background of the document defining security graphics in the void formed by the outline. The printer will eventually fill the void with the second gray scale after using the first gray scale to fill the background of the document. The printer-resident font is used by the PDL to locate and position the security graphics on the document given the designated format (i.e., character set, family, size, treatment, etc.). The printer is also supplied with either an image or text that comprises the security graphics, such as the word “VOID” or “PHOTOCOPY” or a logo or picture. The printer-resident font creates the appropriate graphics from this input.

In a preferred embodiment of the present invention, a visual interference pattern to be applied over the background pattern is also supplied to the printer. The pattern can developed from a font, bitmap, or other graphical object, and will preferably be adaptable to varying sizes and shapes of areas to be covered. The purpose of this interference pattern is to break up the background visually, which helps to mask the differences in the two gray scales. The visual interference pattern should be primarily transparent in that it functions to visually diffuse the background “beneath” it without obfuscating the graphical images on the document. An example of a visual interference pattern is illustrated in FIG. 3.

If the security graphics are to be located on some portions of the document but not others, then the printer can also be provided with regions of inclusion and exclusion. Inclusion regions specify where on the document the security graphics are to be found. The inclusion regions will preferably be specified in PDL coordinate space units relative to an origin on the document. For example, the upper left corner of of parallel lines, the field comprising parallel lines in a first direction and the security graphics comprising parallel lines in a second direction.

In a preferred embodiment, the next step is to print the visual interference pattern. Again using a white or erase font, the interference pattern is placed over the entire inclusion region. FIG. 5 illustrates an example of a visual interference pattern. As can be seen from FIG. 5, the visual interference pattern erases the first gray scale and the second gray scale in the places where the interference pattern overlays the field and security graphics, respectively. Finally, using the white or erase font, any exclusion regions are printed creating a void or blank space in these locations without any gray scale.

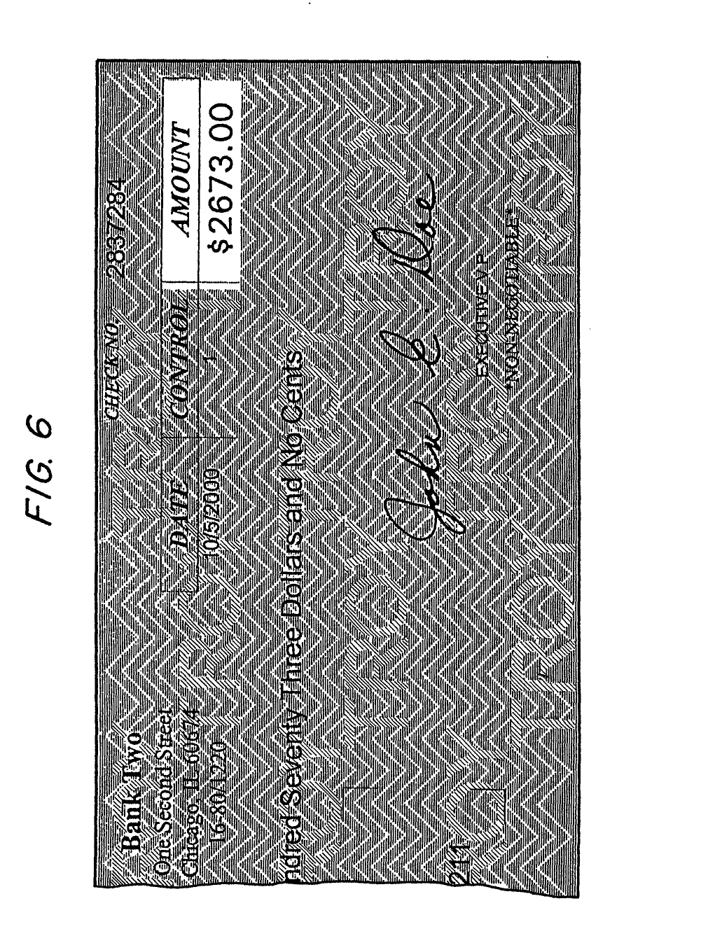

Using the above described steps, a document such as that shown in FIG. 6 can be printed. Note that the word “TROY” is visible in the background of the document because the line drawings required to illustrate the present invention render the security image much more obvious than that of finely spaced lines using a check printing machine. In reality, the two gray scales are so similar as to render the word “TROY” invisible to the casual observer. The amount box and the signature line are exclusion regions where no gray scale appear. The visual interference pattern is seen on the face of the document, and the background “beneath” the visual interference pattern appears to be a uniform, single shade gray scale.

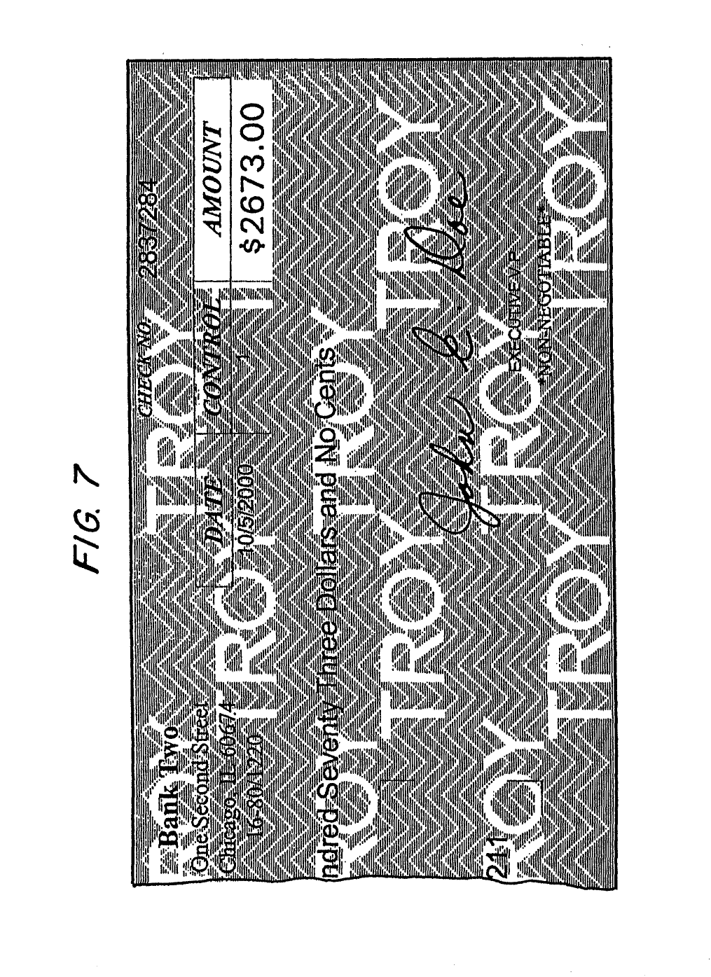

When the document in FIG. 6 is scanned either by a copying machine or other scanning device, the image obtained in shown in FIG. 7. As can be appreciated, the background or “wallpapering” of the document includes security graphics (in this case, text) indicating the amount found in the original document's amount box and the word “COPY” repeated across the face of the duplicate or scanned an inclusion region defined by x and y coordinates, in addition to the width and height of the region, are provided. Also, it may be preferable in some documents to provide exclusion regions within the inclusion regions should there be some locations on the document that should not include the security graphics, such as for example a signature line or an amount box. In this case, the exclusion regions may be defined with respect to a new origin on the inclusion region (such as, for example, the upper left-hand corner discussed above).

When the foregoing data has been provided to the printer, the following steps are taken to create the security graphics on a document. The first step calls for the printer to print the first gray scale pattern in each of the inclusion regions prior to any other printing operations. This first gray scale pattern will typically be comprised of horizontal or vertical lines. After the first gray scale has been printed in each of the inclusion regions, the next step is to erase a portion of the just printed first gray scale to coincide with the security graphics to be placed on the document. Using a white or erase fill pattern, the printer prints the text or image of the security graphics in the inclusion region, and in the process removes the first gray scale in the shape of the security graphics. FIG. 4 illustrates an example of the document after this step has been carried out.

After the printer has effectively removed the first gray scale in the inclusion region in the shape of the security graphics, the next step is to repeat the print operation replacing the white fill or erase font with the second gray scale. That is, the just-erased portions of the document are now completely filled with the second gray scale, causing the entire inclusion region to appear filled with a common background. Only by very close inspection can it be discerned that the region is comprised of two sets image. This serves several important functions. Foremost, the security images identify the document as a copy of the original document thereby alerting the recipient of the document that it is not the original. Additionally, if presented with the original document one need only to scan the original document to discern the amount originally printed in the amount box, and thus prevent alteration of the document to fraudulently increase the amount. Similarly, the payee's name can be part of the security graphics or other pertinent data such as the date or the payer's correct signature. Having a scanning machine (such as a scanner or photocopy machine) nearby allows the recipient to rapidly verify critical data with respect to the document

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A method for printing a document comprising the steps of:
printing a first gray scale on the document comprising a plurality of uniform parallel lines;
erasing a portion of the gray scale printed in the preceding step such that the erased portion defines an area corresponding to a security graphic;
printing a second gray scale comprising a plurality of uniform parallel lines angularly offset from the parallel lines of the first gray scale, on the erased portion defining the security graphic;
where the spacing between the parallel lines and the thickness of the lines are the same for the first and the second gray scales.

2. A document printed by the method disclosed in claim 1.

3. The method for printing of claim 1 further comprising the step of printing a visual interference pattern over the document.

4. A document printed by the method disclosed in claim 3.

5. The method of printing of claim 3 wherein the visual interference pattern comprises a plurality of intersecting diagonal lines.

6. The method for printing of claim 1 further comprising erasing a portion of the first gray scale at predetermined locations where no gray scale is to be located.

7. The method for printing of claim 1 wherein the security graphic includes textual characters.

8. The method for printing of claim 7 wherein the security graphic includes a name of a payee.

9. The method of printing of claim 7 wherein the security graphic includes a monetary amount.

10. The method of printing of claim 7 wherein the security graphic is lighter than the surrounding background when the document is scanned using a raster scanning technique.

11. The method of printing of claim 1 wherein one of the gray scales comprises uniform parallel lines oriented in a horizontal direction relative to the document.

12. The method of printing of claim 1 wherein one of the gray scales comprises uniform parallel lines oriented in a vertical direction relative to the document.

13. An apparatus for printing a security graphic on a document comprising:
first gray scale printing means for printing a first gray scale over the background of the document;
first gray scale removing means for removing a selected portion of the first gray scale corresponding to the security graphic;
second gray scale printing means for printing a second gray scale over the selected portion of the removed first gray scale; and
visual interference pattern printing means for printing a visual interference pattern over the background and the selected portion of the removed first gray scale.

14. A method for printing a background of a check comprising the steps of:
identifying any location on the check where no background is to be printed;
printing a first series of parallel lines throughout the face of the check;
printing a blanking font over the locations on the check identified has where no background is to be printed;
printing the blanking font in a shape of a security graphic over the first series of parallel lines, thereby removing a portion of the first series of parallel lines and leaving a void in the shape of the security graphic within the first series of parallel lines;
printing a second series of parallel lines in the void in the shape of the security graphic, where the second series of parallel lines are similar to the first series save the angular orientation of the lines; and
printing a continuous visual interference pattern over the first and second series of parallel lines comprising a plurality of diagonal lines, where the diagonal lines of the visual interference pattern are thicker than the lines of the first and second series of parallel lines.

15. A document having a hidden character string on a face of the document, where said character string corresponds to an original character string on the face of the document, and where the hidden character string can be revealed using a scanning operation to verify a current character string on the face of the document with the original character string.

16. The document of claim 15 wherein the hidden character string represents a monetary value.

17. The document of claim 15 wherein the hidden character string represents the name of a payee.
